(19) United States
(12) Patent Application Publication
(10) Pub. No.: US 2009/0275000 A1
(43) Pub. Date: Nov. 5, 2009

(54) System and Method for Securing Multiple Ceramic Dental Blocks for Milling

(76) Inventors: Yunoh Jung, Murray, UT (US); Daniel Yonil Jung, Murray, UT (US)

Correspondence Address: THORPE NORTH & WESTERN, LLP., P.O. Box 1219, SANDY, UT, 84091-1219, US

(21) Appl. No.: 12/431,568

(22) Filed: Apr. 28, 2009

(51) Int. Cl. A61C 5/10

(52) U.S. Cl. 433/223

(57) ABSTRACT

A system and method for milling dental prostheses in a CNC milling includes affixing a lateral side of each of a plurality of ceramic millable dental blanks to a lateral wall of a fixture; securing the fixture to a chuck of the milling machine; wet milling a single dental prosthesis in each of the plurality of ceramic millable dental blanks with a diamond burred cutter; and removing the plurality of ceramic millable dental blanks from the fixture.

### BACKGROUND

1. Field of the Invention

The current invention relates to production of dental prosthesis, such as crowns, bridges, inlays and onlays, and the like, and more particularly to a milling fixture system for securing multiple ceramic dental blocks in a CNC wet milling machine that mills dental prostheses from the ceramic dental blocks based on computer generated models of a patient's teeth.

2. Related Art

Computer Aided Design and Computer Aided Manufacturing (CAD/CAM) technology has had a big impact on the dental laboratory industry. Dental professionals can use these systems for designing a product and for controlling the manufacturing process. For example, once a dental prosthesis design has been produced with dental CAD software, CAM software controls the machines that construct the final product. The input information regarding the design of the dental prosthesis can either be created directly from the dentist's office based on a patient's intra oral image or can be created in dental laboratories based on a stone model image (or a milled or 3D printed model) which is reproduced by pouring into a dental impression or based directly on the dental impression.

So far, various CAD/CAM systems have been able to make frameworks and/or full contoured dental prosthesis for single crowns, bridges, inlays and onlays as well as custom implant abutments, and temporaries. These various CAD/CAM systems mill materials such as aluminous oxide, zirconium oxide, lithium disilicate glass ceramic, titanium, resin, feldspathic porcelain-based glass ceramics or resin-based composite blocks.

One example of a CAD/CAM made framework and/or a full contoured dental prosthesis in the dental laboratory includes making precise die models and articulated models using conventional modeling techniques which are then photographed with 3 dimensional dental optical scanners. The model is scanned in different positions and the scans are then used to calculate 3D image data. The bite record and tissue areas are also scanned. The data is processed to generate a precise 3D digital representation of the patient's mouth and/or teeth with an average marginal gap of 30 microns or under. Once all the data is calculated and the necessary 3D design of the prosthesis is done by a dental technician, it is transferred to a dental CNC milling machine.

Typical dental CNC milling machines are three dimensional mills that move a rotary cutter through an x, y, z axis envelope. A porcelain based raw material blank can be installed in a chuck or fixture within the envelope and the mill head can be moved around the blank to cut and form the blank into a desired shape. The desired shape is usually programmed into the CNC milling machine controller via a CAM based software program. Unfortunately, some milling machines can only machine a single blank at a time, resulting in the production of a single dental prosthesis. If additional dental prostheses are needed, after one blank is milled, a new blank must be installed into the fixture for machining.

To overcome the time consuming reloading procedures and problems, some CAD/CAM systems have been developed that utilize relatively large blanks of various shapes for the production of multiple prostheses. Unfortunately, due to the nature of the blank having the same material composition throughout the blank, the choice of different colors, hardness, or other material properties from a single blank is not possible. It has not been possible with current dental CAD/CAM milling machine systems to produce multiple dental prostheses, with each prosthesis having differing material properties, such as color, ceramic composition, and the like, without having to load and reload different blanks into the milling machine.

Examples of milling machines that utilize large discs or blocks of a single material into which multiple dental prostheses can be milled include the Weiland ZENO™ milling machine, the Tizian milling machine, and the Katana milling machine. Alternatively, the CEREC milling machine utilizes a single small block in which a single prosthesis is milled.

Another attempt to solve some of these problems uses a method of securing a dental blank in a moldable material shaped to fit within a mill fixture. In this systems, the milling machine mills from a top side to eliminate the unnecessary part of the dental blank and the moldable material. Unfortunately, the machine must be temporarily stopped to turn over the dental blank and to add additional moldable material to hold the dental blank in place in order to prevent the dental blank from falling out of the fixture or becoming dislodged during subsequent milling operation. Thus, such operations are not only time consuming and inefficient because the machine must be stopped, but also add additional possibilities of manufacturing mistakes due to instabilities in the moldable material such as bubbles or cavitations that may cause weak areas that make the dental blank unstable in the milling fixture.

### SUMMARY OF THE INVENTION

It has been recognized that it would be advantageous to develop a method and system to mill multiple ceramic blanks of different characteristics, such as colors and compositions, in a single milling cycle. Additionally, it has been recognized that it would be advantageous to develop a method and system for mounting and registering ceramic dental blanks having different material characteristics in a single apparatus. In addition, it has been recognized that it would be advantageous to develop a method and system to mill a substructure (coping) of a dental prosthesis, framework, inlay, onlay, implant abutment, a full contoured crown or bridge from different shades of ceramic at one single milling cycle time.

The invention provides a method for milling dental prostheses in a CNC milling machine, includes: affixing a lateral side of each of a plurality of ceramic millable dental blanks to a lateral wall of a fixture; securing the fixture to a chuck of the milling machine; wet milling a single dental prosthesis in each of the plurality of ceramic millable dental blanks with a diamond burred cutter; and removing the plurality of ceramic millable dental blanks from the fixture

In addition, the invention provides a system for milling dental prostheses. The system includes a CNC milling machine with a chuck, a diamond burred cutter, and a liquid cutting system. A fixture is securable in the chuck of the milling machine. The system also includes a plurality of ceramic millable dental blanks each capable of being machined to form a dental prosthesis. A lateral side of each of the plurality of ceramic millable dental blanks is securable to a lateral wall of the fixture.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a partial exploded view of a dental milling system in accordance with an embodiment of the present invention showing a plurality of ceramic millable dental blanks received in a fixture of a milling machine;

FIG. 2 is a partial detailed exploded view of the dental milling system of FIG. 1;

FIG. 3 is an exploded view of the fixture of FIG. 1;

FIG. 4 is a top view of the fixture of FIG. 1;

FIG. 5 is a perspective view of the fixture of FIG. 1 with a plurality of ceramic millable dental blanks;

FIG. 6 is a perspective view of the fixture of FIG. 1;

FIG. 7 is a cross-sectional side view of the fixture of FIG. 1 taken along line 7;

FIG. 8 is a partial detailed exploded view of another dental milling system with another fixture in accordance with an embodiment of the present invention;

FIG. 9 is a partial detailed exploded view of another dental milling system with another fixture in accordance with an embodiment of the present invention;

FIG. 10 is a partial detailed exploded view of another dental milling system with another fixture in accordance with an embodiment of the present invention;

FIG. 11 is a perspective schematic view of another fixture of the dental milling system in accordance with the present invention;

FIG. 12 is a top view of the fixture of FIG. 11;

FIG. 13 is a schematic view of a method of forming a dental prosthesis in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

The present invention provides a system and method for milling dental prostheses in a plurality of different ceramic dental blocks in a single milling cycle time using a fixture that holds the plurality of different ceramic blocks in a CNC milling machine.

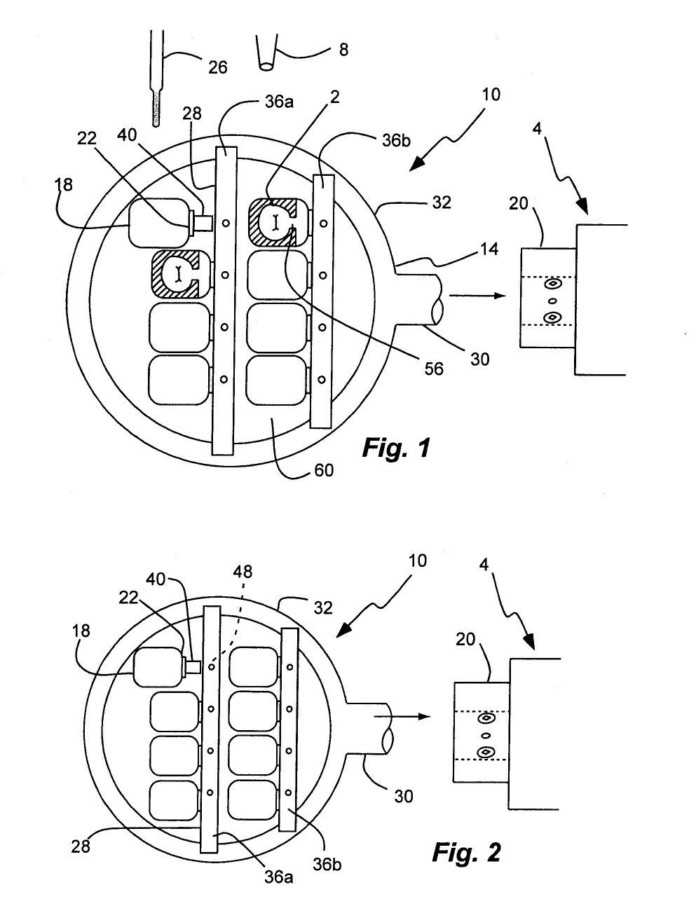

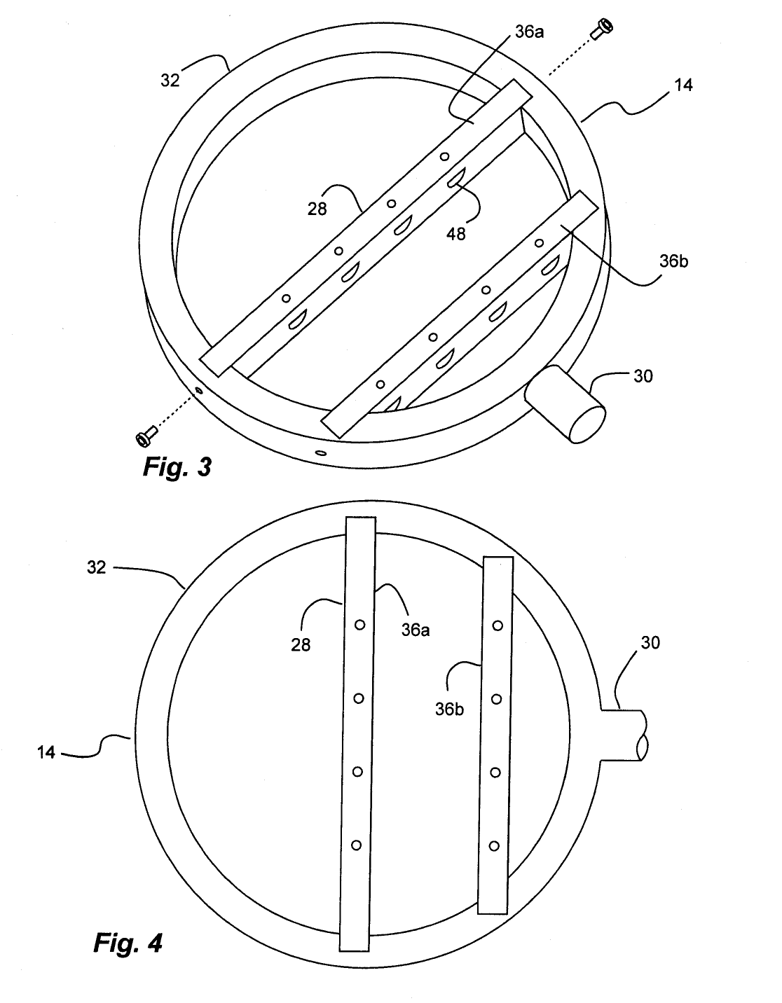

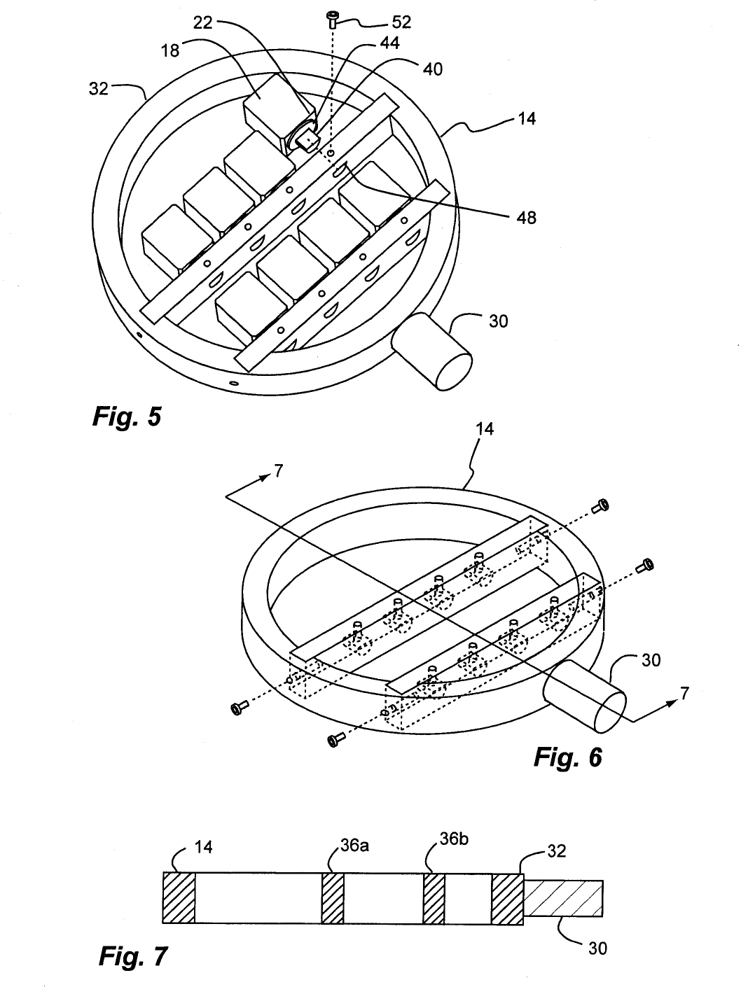

As illustrated in FIGS. 1-7, a system, indicated generally at 10, in an example implementation in accordance with the present invention is shown for milling dental prostheses 2 in a CNC milling machine 4. The dental prostheses 2 can include crowns, bridges, copings, etc. The CNC milling machine can be a wet milling machine with a cutting fluid system, indicated generally at 8. The CNC milling machine 4 can include a fixture 14 for receiving and holding a plurality of ceramic millable dental blanks 18, each capable of having a single dental prosthesis 2 milled therein. The ceramic millable dental blanks 18 can be rectangular or cylindrical blocks of lithium disilicate glass ceramic. In addition, the ceramic millable dental blanks 18 can each have a different characteristic, such as color. The milling machine can include a chuck 20 or the like for securely holding the fixture 14, and one or more cutting tools 26 to mill the blanks 18. The cutting tools 26 can be diamond burred cutters with a diamond cutting surface or covering to mill the ceramic material.

The system 10 can include fixture 14 that receives and holds a plurality of ceramic millable dental blanks 18 that are capable of being machined to form a plurality of dental prosthesis 2, each with a different property or characteristic, such as material or color. The ceramic millable dental blanks 18 can be rectilinear blocks or cylinders with a lateral side 22 affixed to, or with respect to, the fixture 14. The ceramic blanks 18 can have various different properties and/or characteristics with respect to one another, including color, material, etc. The fixture 14 has a rod 30 or the like receivable and securable in the chuck 20 of the milling machine. The rod 30 can have the same size and diameter as a post 40 described below. The fixture 14 has a lateral internal wall 28 against which the lateral side 22 of the ceramic blanks 18 are affixed. The fixture allows a plurality of ceramic blanks with different properties and/or characteristics to be held by the chuck and milled by the milling machine in a single milling cycle time. Thus, a plurality of different prostheses, with different properties and/or characteristics, such as color and/or material, can be efficiently and conveniently milled together in the same machine, but without having to stop the machine and replace the blanks with different colors or materials.

The fixture 14 can be a ring 32 with one or more cross members 36a and 36b spanning the ring in a spaced-apart relationship. The cross members can have or can define the lateral wall 28. The fixture or ring can have an open interior space open from both sides of the ring. The ceramic blanks 18 are disposed in the open interior space and have their lateral side 22 affixed to the lateral wall 28 of the cross-members 36a and 36b. The fixture can be configured to carry eight ceramic blanks 18 of different properties or characteristics in a single fixture. The ring and cross members can be metal. The cross members can have opposite ends disposed in interior notches of the ring, and secured with a fastener, such as a screw or bolt.

In accordance with one aspect of the present invention, the ceramic blanks 18 can be affixed to the fixture 14 with a post 40. A face 44 of the post can be directly adhered to the lateral side 22 of the ceramic blank 18. The face 44 can be enlarged with respect to the post. The post can be received and secured in a hole 48 of the fixture or cross members. The hole and the post can be shaped or keyed to align a surface of the ceramic blank with respect to the fixture, and thus the milling machine. The post can be retained in the hole with a set screw 52 or the like. The set screw can thread through an orthogonal bore perpendicular to the hole in the cross member to abut to the post or flat surface thereof.

The fixture 18 can be configured to arrange the ceramic blanks 18 in a flat layer with a top and a bottom of each of the plurality of ceramic millable dental blanks unblocked by another of the plurality of ceramic millable dental blanks so that the cutting tool can access all of the blanks without removing any blank to provide access to another blank.

With the ceramic blanks 18 held by the fixture 14 in the chuck, the milling machine can mill the ceramic blanks. For example, a cutting tool of the milling machine can access the ceramic blanks via the open ring of the fixture, and can mill the top (or bottom) and at least an upper (or lower) portion of the perimeter sides of the ceramic blanks 18 to form the dental prostheses 2 in the ceramic blanks. The fixture 14 can turn over to allow the cutting tool of the milling machine to mill the bottom (or top) and at least a lower (or upper) portion of the perimeter sides of the smaller blanks to complete the dental prostheses 2. The dental prostheses 2 can remain attached to the remainder of the ceramic blanks 18 by a connector 56 extending between the prosthesis 2 and the lateral side 22 of the ceramic blank 18. Thus, the prostheses 2 remain coupled to the post 40 and the fixture 14. The lateral side 22 of ceramic blanks 18 remains attached to the lateral wall 28 of the fixture 14 or cross members after the prostheses are milled into the ceramic blank. Thus, the prostheses remain secured during the process. Only a single lateral side 22 of each of the ceramic blanks 18 can be affixed, and the ceramic blanks each have lateral space 60 around three sides, to allow for motion of the cutting tool of the milling machine.

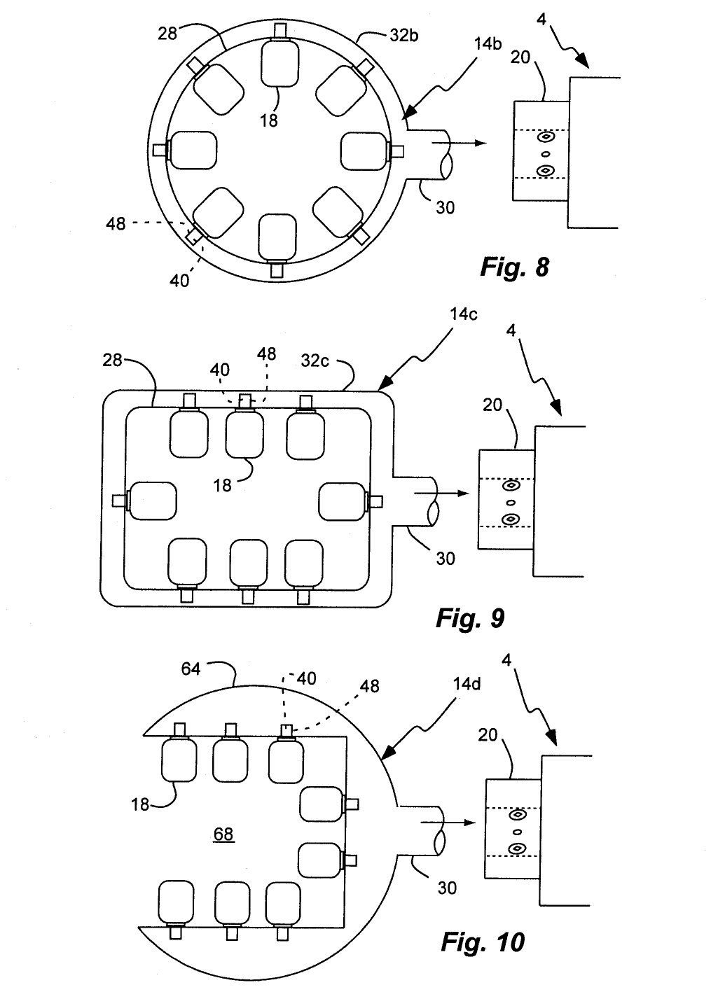

The fixture can have different shapes and/or configurations. Referring to FIG. 8, the fixture 14b can have a circular ring 32b with an open interior without any cross members. The lateral wall 28 can be defined by the inner perimeter of the ring 32b. The ceramic blanks 18 can be affixed to the lateral wall 28 with the posts 40 extending into holes 48 formed directly in the ring itself. Referring to FIG. 9, the fixture 14c can have a rectilinear ring or hoop 32c. Referring to FIG. 10, the fixture 14d can have a yoke or fork 64 with the lateral wall 28 formed by an interior wall of a cavity 68 in the yoke or fork. The ceramic blanks 18 can be affixed to the lateral wall 28 with the posts 40 extending into holes 48 formed directly in the yoke itself.

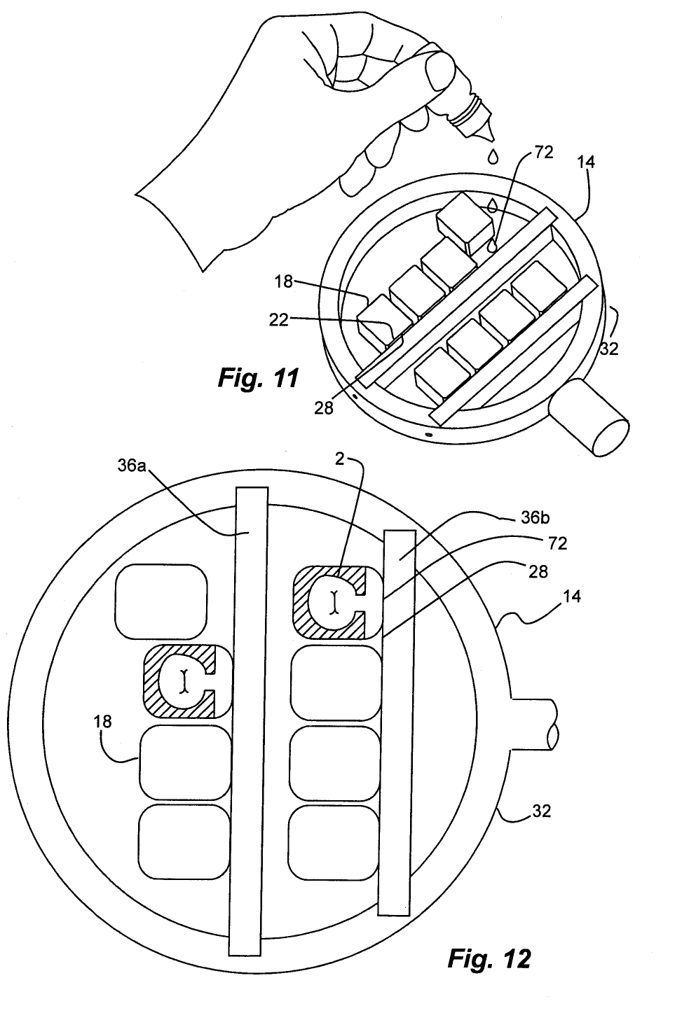

In accordance with another aspect of the present invention, the smaller blanks 18 can be directly adhered to the inner wall 28 of the fixture 14 using an adhesive 72. Referring to FIGS. 11 and 12, each of the ceramic blanks 18 has its lateral side 22 adhered to the lateral wall 28 of the cross members 36a and 36b.

A method for utilizing the system and fixture described above, and for milling dental prostheses 2 in a CNC milling machine 4, includes affixing a lateral side 22 of each of a plurality of ceramic millable dental blanks 18 to a lateral wall 28 of a fixture 14. The plurality of ceramic millable dental blanks 18 can be disposed in a flat layer with a top and a bottom of each of the plurality of ceramic millable dental blanks unblocked by another of the plurality of ceramic millable dental blanks. The plurality of ceramic millable dental blanks can be obtained with each having a post 40 with a face 44 secured to the lateral side of the blank. The post of each of the plurality of ceramic millable dental blanks can be disposed in a different one of a plurality of holes 48 in the fixture. Alternatively, the lateral side of each of the plurality of ceramic millable dental blanks can be adhered to the lateral wall of the fixture. The lateral side of each of the plurality of ceramic millable dental blanks can be affixed to an interior wall of a hoop of the fixture. The lateral side of each of the plurality of ceramic millable dental blanks can be affixed to a cross-member in a hoop of the fixture. In addition, the plurality of ceramic millable dental blanks can be obtained with each having a different characteristic, such as color.

The fixture is secured to a chuck 20 of the milling machine. A single dental prosthesis 2 is wet milled in each of the plurality of ceramic millable dental blanks 18 with a diamond burred cutter 26. A top side of each of the plurality of ceramic millable dental blanks can be milled; the fixture can be turned over; and an opposite bottom side of each of the plurality of ceramic millable dental blanks can be milled. The plurality of ceramic millable dental blanks is removed from the fixture. The dental prostheses 2 can be removed from the dental blanks 18 or posts 40 by cutting the connectors 56.

In accordance with another aspect of the present invention, the fixture can be interchanged with a single ceramic millable dental blank by removing the fixture from the chuck and securing a post of the single ceramic millable dental blank to the chuck. The single ceramic millable dental blank can be wet milled with the diamond burred cutter. Thus, the system can mill both groups of ceramic blanks, and individual blanks.

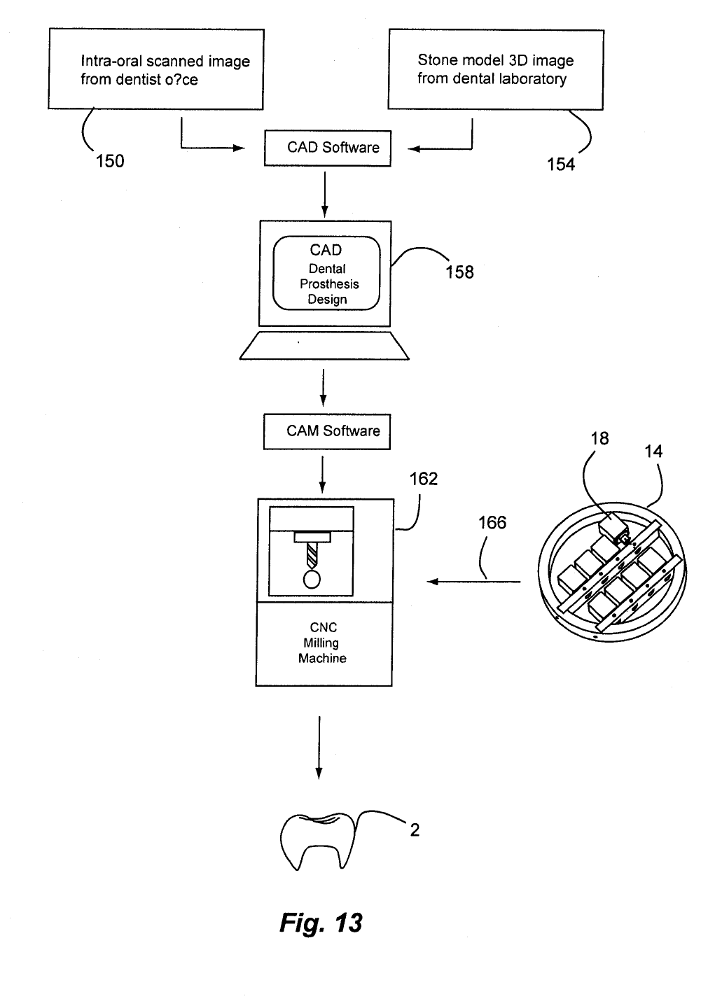

Referring to FIG. 13, the method can further include obtaining an image of the patient's teeth, such as with an intra-oral scan 150 or based on a stone model 154. CAD software is used to design 158 a dental prosthesis. CAM software is used to control a cutting tool of milling machine that mills 162 a ceramic blank 18 placed 166 in the milling machine to obtain a dental prosthesis 2.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for milling dental prostheses in a CNC milling machine, comprising:
affixing a lateral side of each of a plurality of ceramic millable dental blanks to a lateral wall of a fixture;
securing the fixture to a chuck of the milling machine;
wet milling a single dental prosthesis in each of the plurality of ceramic millable dental blanks with a diamond burred cutter; and
removing the plurality of ceramic millable dental blanks from the fixture.

2. A method in accordance with claim 1, wherein affixing further comprises:
disposing the plurality of ceramic millable dental blanks in a flat layer with a top and a bottom of each of the plurality of ceramic millable dental blanks unblocked by another of the plurality of ceramic millable dental blanks.

3. A method in accordance with claim 1, wherein milling further comprises:
milling a top side of each of the plurality of ceramic millable dental blanks;
turning the fixture over; and
milling an opposite bottom side of each of the plurality of ceramic millable dental blanks.

4. A method in accordance with claim 1, wherein affixing further comprises:
obtaining the plurality of ceramic millable dental blanks each having a post with a face secured to the lateral side of the blank; and
disposing the post of each of the plurality of ceramic millable dental blanks in a different one of a plurality of holes in the fixture.

5. A method in accordance with claim 1, wherein affixing further comprises:
obtaining the plurality of ceramic millable dental blanks each having a different characteristic.

6. A method in accordance with claim 1, wherein affixing further comprises:
affixing the lateral side of each of the plurality of ceramic millable dental blanks to an interior wall of a hoop of the fixture.

7. A method in accordance with claim 1, wherein affixing further comprises:
affixing the lateral side of each of the plurality of ceramic millable dental blanks to a cross-member in a hoop of the fixture.

8. A method in accordance with claim 1, wherein affixing further comprises:
adhering the lateral side of each of the plurality of ceramic millable dental blanks to the lateral wall of the fixture.

9. A method in accordance with claim 1, further comprising:
interchanging the fixture with a single ceramic millable dental blank by removing the fixture from the chuck and securing a post of the single ceramic millable dental blank to the chuck; and
wet milling the single ceramic millable dental blank with the diamond burred cutter.

10. A method for milling dental prostheses in a CNC milling machine, comprising:
affixing a lateral side of each of a plurality of ceramic millable dental blanks to an internal lateral wall of a hoop of a fixture by disposing a post of each of the plurality of ceramic millable dental blanks in a different one of a plurality of holes in the fixture, with the plurality of ceramic millable dental blanks disposed in a flat layer with a top and a bottom of each of the plurality of ceramic millable dental blanks unblocked by another of the plurality of ceramic millable dental blanks, each of the plurality of ceramic millable dental blanks having a different characteristic with respect to one another;
securing the fixture to a chuck of the milling machine;
wet milling a single dental prosthesis in each of the plurality of ceramic millable dental blanks with a diamond burred cutter by first milling a top side of each of the plurality of ceramic millable dental blanks, turning the fixture over, and then milling an opposite bottom side of each of the plurality of ceramic millable dental blanks; and
removing the plurality of ceramic millable dental blanks from the fixture.

11. A method in accordance with claim 10, wherein affixing further comprises:
affixing the lateral side of each of the plurality of ceramic millable dental blanks to a cross-member in the hoop of the fixture.

12. A method in accordance with claim 10, further comprising:
interchanging the fixture with a single ceramic millable dental blank by removing the fixture from the chuck and securing a post of the single ceramic millable dental blank to the chuck; and
wet milling the single ceramic millable dental blank with the diamond burred cutter.

13. A system for milling dental prostheses, comprising:
a) a CNC milling machine with a chuck, a diamond burred cutter, and a liquid cutting system;
b) a fixture securable in the chuck of the milling machine;
c) a plurality of ceramic millable dental blanks each capable of being machined to form a dental prosthesis; and
d) a lateral side of each of the plurality of ceramic millable dental blanks securable to a lateral wall of the fixture.

14. A system in accordance with claim 13, further comprising:
a plurality of posts each having a face directly adhered to the lateral side of a different one of the plurality of ceramic millable dental blanks; and
a plurality of holes in the fixture receiving the plurality of posts.

15. A system in accordance with claim 14, wherein the fixture further comprises:
a ring with at least one cross member defining the lateral wall.

16. A system in accordance with claim 14, wherein the fixture further comprises:
a rod receivable in the chuck and having a same diameter as the plurality of posts.

17. A system in accordance with claim 13, wherein the plurality of ceramic millable dental blanks includes ceramic millable dental blanks with different colors or materials.

18. A system in accordance with claim 13, wherein only a single lateral side of each of the plurality of ceramic millable dental blank is affixed.
